(19) United States
(12) Patent Application Publication
(10) Pub. No.: US 2026/0113185 A1
(43) Pub. Date: Apr. 23, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Toshihiko OKAMURA, Tokyo (JP); Tetsuo Kawakami, Tokyo (JP); Hiroki Kawahara, Tokyo (JP)

(73) Assignee: NEC Corporation, Tokyo (JP)

(21) Appl. No.: 19/349,022

(22) Filed: Oct. 3, 2025

(30) Foreign Application Priority Data
Oct. 23, 2024 (JP) 2024-186651

(51) Int. Cl. H04L 9/08; H03M 7/30

(52) U.S. Cl. CPC H04L 9/0858; H03M 7/70

(57) ABSTRACT

An information processing apparatus is provided that includes at least one memory storing instructions, and at least one processor configured to execute the instructions to receive information necessary for calculating a compression rate in privacy amplification processing in a quantum key distribution from a quantum key distribution device, determine the compression rate, based on the received information, and transmit information indicating the determined compression rate to the quantum key distribution device.

### INCORPORATION BY REFERENCE

This application is based upon and claims the benefit of priority from Japanese patent application No. 2024-186651, filed on Oct. 23, 2024, the disclosure of which is incorporated herein in its entirety by reference.

### TECHNICAL FIELD

The present disclosure relates to an information processing apparatus, an information processing method, and a non-transitory computer-readable medium.

### BACKGROUND ART

JP 2020-005166 A discloses a technique for determining a compression rate in privacy amplification processing of a quantum cryptography (a data length of a quantum key output per privacy amplification processing/a data length of a corrected key input per privacy amplification processing) with reference to a table.

### SUMMARY

However, in the technique described in JP 2020-005166 A, for example, there is room for further improvement in accuracy of a compression rate in privacy amplification processing.

In view of the above problems, an example object of the present disclosure is to provide a technology capable of appropriately determining a compression rate in privacy amplification processing.

In a first example aspect according to the present disclosure, an information processing apparatus is provided that includes at least one memory storing instructions, and at least one processor configured to execute the instructions to receive information necessary for calculating a compression rate in privacy amplification processing in a quantum key distribution from a quantum key distribution device, determine the compression rate, based on the received information, and transmit information indicating the determined compression rate to the quantum key distribution device.

In a second example aspect according to the present disclosure, an information processing method is provided that includes receiving information necessary for calculating a compression rate in privacy amplification processing in a quantum key distribution from a quantum key distribution device, determining the compression rate, based on the received information, and transmitting information indicating the determined compression rate to the quantum key distribution device.

In a third example aspect according to the present disclosure, a non-transitory computer-readable medium is provided that stores a program for causing a computer to execute processing including receiving information necessary for calculating a compression rate in privacy amplification processing in a quantum key distribution from a quantum key distribution device, determining the compression rate, based on the received information, and transmitting information indicating the determined compression rate to the quantum key distribution device.

According to one aspect, a compression rate in privacy amplification processing can be appropriately determined.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating an example of a configuration of an information processing apparatus that executes generation processing according to an example embodiment;

FIG. 2 is a diagram illustrating a configuration example of a quantum key distribution system according to the example embodiment;

FIG. 3 is a diagram illustrating a hardware configuration example of the information processing apparatus according to the example embodiment;

FIG. 4 is a diagram illustrating QKD key distillation processing according to the example embodiment; and

FIG. 5 is a flowchart illustrating an example of processing of the information processing apparatus according to the example embodiment.

### EXAMPLE EMBODIMENT

The principles of the present disclosure will be described with reference to several example embodiments. It is to be understood that these example embodiments have been described for purposes of illustration only and will aid those skilled in the art in understanding and carrying out the present disclosure without suggesting limitations on the scope of the present disclosure. The disclosure described herein is implemented in various methods other than those described below.

In the following description and claims, unless defined otherwise, all technical and scientific terms used herein have the same meaning as commonly understood by those skilled in the art of the technical field to which the present disclosure belongs.

Hereinafter, example embodiments of the present disclosure will be described with reference to the drawings. Each of the drawings is merely an example to illustrate one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other figures, for example, to create an example embodiment that is not explicitly illustrated or described. All of the features or steps illustrated in any one of the figures for describing illustrative example embodiments are not necessarily mandatory, and some features or steps may be omitted. An order of the steps described in any of the figures may be changed as appropriate.

### First Example Embodiment

### <Configuration>

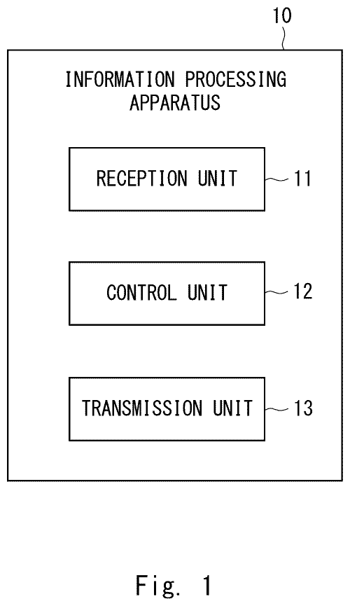

Next, a configuration of an information processing apparatus 10 according to an example embodiment will be described with reference to FIG. 1. FIG. 1 is a diagram illustrating an example of the configuration of the information processing apparatus 10 according to the example embodiment. The information processing apparatus 10 includes a reception unit 11, a control unit 12, and a transmission unit 13. These units may be achieved by cooperation of one or more programs installed in the information processing apparatus 10 and hardware such as a processor or a memory of the information processing apparatus 10.

The reception unit 11 receives information necessary for calculating a compression rate in privacy amplification processing in a quantum key distribution, from a quantum key distribution device (a QKD device). The control unit 12 determines the compression rate, based on the information received by the reception unit 11. The transmission unit 13 transmits information indicating the compression rate determined by the control unit 12, to the quantum key distribution device.

### Second Example Embodiment

### <System Configuration>

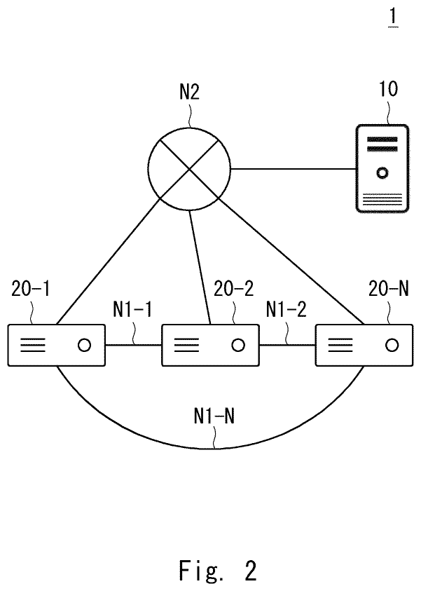

Next, a configuration of a Quantum Key Distribution (QKD) system 1 according to an example embodiment will be described, with reference to FIG. 2. FIG. 2 is a diagram illustrating a configuration example of the quantum key distribution system 1 according to the example embodiment. In the example in FIG. 2, the quantum key distribution system 1 includes an information processing apparatus 10. The quantum key distribution system 1 includes a QKD device 20-1, a QKD device 20-2, . . . , and a QKD device 20-N (N is an integer of two or more) (in a case where it is not necessary to distinguish the QKD devices from each other in the present disclosure, the QKD devices are simply referred to as a “QKD device 20”).

In the example in FIG. 2, the information processing apparatus 10 and the QKD device 20 are communicably connected by a public communication path N2. Examples of the public communication path N2 include the Internet, a mobile communication system, a wireless Local Area Network (LAN), short-range wireless communication such as Bluetooth Low Energy (BLE), a LAN, a bus, and the like. Examples of the mobile communication system include a fifth generation mobile communication system (5G), a fourth generation mobile communication system (4G), a third generation mobile communication system (3G), and the like.

The QKD devices 20-1 and 20-2 are communicably connected with a quantum communication path (a quantum channel) N1-1 such as an optical fiber and the public communication path N2. Similarly, the QKD devices 20-2 and 20-N are communicably connected with a quantum channel N1-2 and the public communication path N2. Similarly, the QKD devices 20-N and 20-1 are communicably connected with a quantum channel N1-N and the public communication path N2. The QKD device 20 is a QKD transmitter or receiver.

The information processing apparatus 10 may house the plurality of QKD devices 20. In this case, the information processing apparatus 10 may determine each compression rate, for each pair (pair) of a transmission-side QKD device 20 and a reception-side QKD device 20 of each of one or more quantum key distributions. As a result, for example, it is possible to calculate the compression rates for the plurality of QKD devices 20. In this case, for example, a network controller (for example, a network-side device) that is a component of a functional architecture of a QKD network may be used as the information processing apparatus 10.

### <Hardware Configuration>

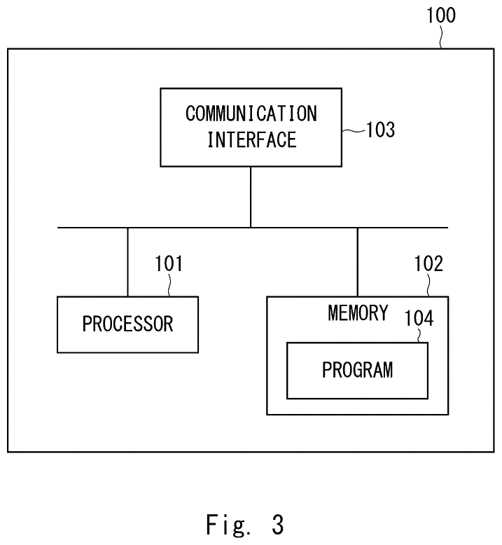

FIG. 3 is a diagram illustrating a hardware configuration example of the information processing apparatus 10 according to the example embodiment. In the example of FIG. 3, the information processing apparatus 10 (a computer 100) includes a processor 101, a memory 102, and a communication interface 103. These units may be connected by a bus or the like. The memory 102 stores at least a part of a program 104. The communication interface 103 includes an interface necessary for communication with other network elements.

In a case where the program 104 is executed by the processor 101, the memory 102, and the like in cooperation with each other, at least a part of the process of the example embodiment of the present disclosure is performed by the computer 100. The memory 102 may be of any type. The memory 102 may be a non-transitory computer-readable storage medium, as a non-limiting example. The memory 102 may also be implemented using any suitable data storage technology, such as semiconductor-based memory devices, magnetic memory devices and systems, optical memory devices and systems, a fixed memory and a removable memory, and the like. Although only one memory 102 is illustrated in the computer 100, there may be several physically different memory modules in the computer 100. The processor 101 may be of any type. The processor 101 may include one or more of a general purpose computer, a dedicated computer, a microprocessor, a Digital Signal Processor (DSP), and a processor based on a multi-core processor architecture as a non-limiting example. The computer 100 may have a plurality of processors, such as an application specific integrated circuit chip that is temporally dependent on a clock that synchronizes a main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor, or other computing devices.

The present disclosure also provides at least one computer program product tangibly stored on a non-transitory computer-readable storage medium. The computer program product includes computer-executable instructions, such as those included in a program module, and is executed on a device on a target real or virtual processor to perform the processes or methods of the present disclosure. The program module includes routines, programs, libraries, objects, classes, components, data structures, and the like that execute particular tasks or implement particular abstract data types. Functions of the program module may be combined or divided between the program modules as desired in various example embodiments. A machine-executable instruction of the program module can be executed in a local or distributed device. In the distributed device, the program modules can be located on both local and remote storage media.

A program code for executing the methods of the present disclosure may be written in any combination of one or more programming languages. These program codes are provided to a processor or controller of a general purpose computer, a dedicated computer, or other programmable data processing devices. In a case where the program code is executed by the processor or controller, the functions/operations in the flowcharts and/or the implemented block diagrams are performed. The program code is executed entirely on a machine, partly on the machine, as a stand-alone software package, partly on the machine, partly on a remote machine, or entirely on the remote machine or a server.

The program includes a group of instructions (or a software code) for causing the computer to perform one or more functions described in the example embodiments in a case where the program is loaded into the computer. The program may be stored in a non-transitory computer-readable medium or a tangible storage medium. As an example and not by way of limitation, a computer-readable medium or tangible storage medium includes a Random-Access Memory (RAM), a Read-Only Memory (ROM), a flash memory, a solid-state drive (SSD) or another memory technology, a CD-ROM, a Digital Versatile Disc (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. By way of example and not limitation, the transitory computer-readable medium or the communication medium includes electrical, optical, acoustic, or any other form of propagated signals.

### <QKD Key Distillation Processing>

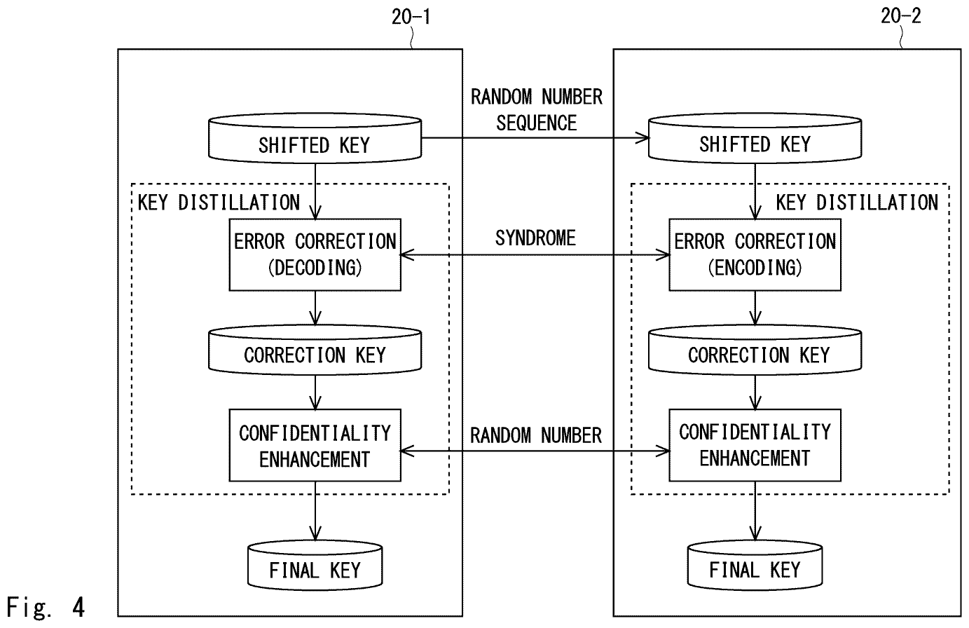

FIG. 4 is a diagram illustrating QKD key distillation processing according to the example embodiment. In the example in FIG. 4, an information processing apparatus 10A transmits data of a random number sequence to an information processing apparatus 10B via a quantum communication path N1. As a result, each information processing apparatus 10 records a random number sequence called a shifted key. The shifted keys of the respective information processing apparatuses 10 do not completely match due to disturbance caused by transmission.

Therefore, each information processing apparatus 10 shares data for error correction (a syndrome, parity information) via the public communication path N2 in error correction processing and generates a key after error correction (a corrected key). Then, each information processing apparatus 10 shares a hash function (for example, a Teplitz matrix or a corrected Teplitz matrix) with the public communication path N2. Here, one of the information processing apparatus 10A (transmitter) and the information processing apparatus 10B (receiver) may randomly select the hash function and disclose the selected hash function to the other with the public communication path N2. There is no problem if the error correction processing is sequentially executed.

Then, the information processing apparatus 10 executes privacy amplification processing which is processing for invalidating eavesdropped information, on the corrected key. As a result, a final key (an encryption key, a shared key) is generated. As described above, the key distillation processing mainly includes the error correction processing and the privacy amplification processing. As an input size (a size of the input corrected key) of the privacy amplification processing is smaller, a final key rate (for example, the number of bits of a final key per photon pulse) becomes smaller (deteriorates) due to security requirements.

### <Processing>

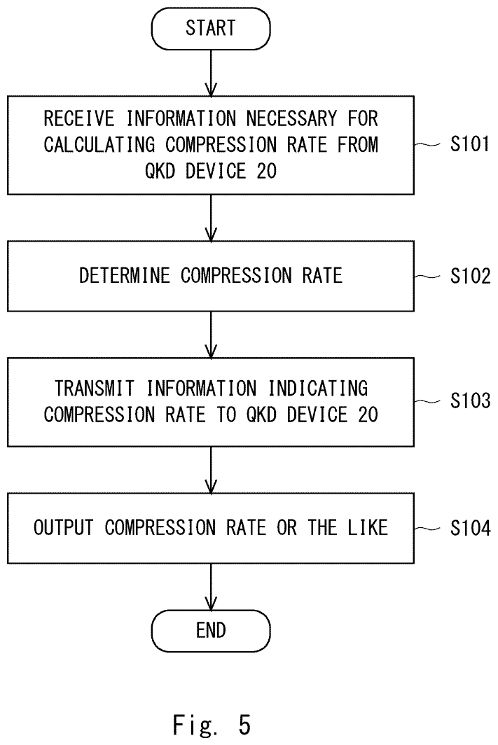

Next, an example of processing of the information processing apparatus 10 according to the example embodiment will be described with reference to FIG. 5. FIG. 5 is a flowchart illustrating an example of the processing of the information processing apparatus 10 according to the example embodiment. Hereinafter, a transmission side (Alice) of a quantum key will be described as the QKD device 20-1, and a reception side (Bob) of the quantum key will be described as the QKD device 20-2.

In step S101, the reception unit 11 receives information necessary for calculating a compression rate γ in the privacy amplification processing in the quantum key distribution, from the QKD device 20. Here, the reception unit 11 may receive the information necessary for calculating the compression rate γ from at least one of the QKD devices 20-1 and 20-2. In a case of receiving the information from the reception-side QKD device 20-2, the reception unit 11 may receive information measured or set by the transmission side, via the reception side. In a case of receiving the information from the transmission-side QKD device 20-1, the reception unit 11 may receive information measured or set by the reception side, via the transmission side.

The information necessary for calculating the compression rate γ may include, for example, information indicating a QKD protocol (for example, a modulation method, a specified security level, or the like).

For example, the information necessary for calculating the compression rate γ may include a measurement value or a setting value of a parameter regarding the quantum channel N1-1. In this case, the information necessary for calculating the compression rate γ may include, for example, at least one of a first-order moment of a reception value, a sample average of a second-order moment of the reception value, a transmission distance by a fiber of the quantum channel N1-1, a transmittance η₁ of the fiber, an excess noise ξ₁ that is a ratio between a noise and a quantum noise in a case where quantum light exists on the reception side, a transmittance (a detector transmittance) η₂ of an optical detector on the reception side, and a noise (a detector noise) ξ₂ of the optical detector on the reception side.

The information necessary for calculating the compression rate γ may include, for example, a setting value of an average number of photons α² of a transmission signal on the transmission side or a setting value of a complex amplitude α. In a case where the modulation method is Quadrature Phase-Shift Keying (QPSK), a quantum state of the transmission signal of Alice can be expressed as a coherent state {|α>, |−α>, |iα>, |−iα>}.

The information necessary for calculating the compression rate γ may include, for example, a setting value of a probability of each symbol of the transmission signal on the transmission side. In a case of the QPSK, a setting value pₓ (x∈{0, 1, 2, 3}) of a probability of each symbol (|α>, |−α>, |iα>, |−iα>) of (0, 1, 2, 3) is usually p₀=p₁=p₂=p₃=¼.

The information necessary for calculating the compression rate γ may include, for example, a setting value of a post selection threshold Δ on the reception side. On the reception side, only a signal of which an absolute value of a quadrature amplitude is equal to or more than the post selection threshold Δ is used to generate a key. In a case where the post selection threshold Δ is set to 0, post selection processing is not executed.

For example, the information necessary for calculating the compression rate γ may include at least one of identification information of the QKD device 20 and information indicating a designated security level of the quantum key distribution. As a result, for example, the compression rate γ can be calculated based on a security level designated by a user or the like, for each QKD device 20.

Subsequently, the control unit 12 determines the compression rate γ, based on the information received by the reception unit 11 (step S102). The compression rate γ may represent the number of bits of the final key per input bit of the privacy amplification processing. In this case, the compression rate γ may be determined, for example, by the following formula (1).

$$γ = β I ( A ; B ) - χ \qquad ( 1 )$$

I (A; B) is a mutual information amount (an encoding rate of ideal error correction) of a shifted key between Alice and Bob. χ indicates an estimated value (a Holevo information amount) of an amount of eavesdropped information, calculated from a QKD protocol and measurement values of Alice and Bob. β indicates an efficiency of error correction on the reception side. βI (A; B) is relevant to an encoding rate of the error correction. In a case where a frame error rate (FER) of the error correction is larger than 0 (FER>0), a right side of the formula (1) may be multiplied by (1−FER).

It is assumed that the protocol of the QKD be Continuous-Variable QKD (CV-QKD) and QPSK modulation, the average number of photons α² of the transmission signal be 0.4, the transmission distance by the fiber of the quantum channel N1-1 be 20 km, and the transmittance η₁ of the fiber be −0.19 dB/km. It is assumed that the detector transmittance η₂ be −4.57 dB, the detector noise ξ₂ be 0.14, the excess noise ξ₁ be 0.0092, the post selection threshold Δ be 1.0, and the efficiency β of the error correction be 0.91.

In this case, for example, in a case where the compression rate γ is calculated by the above formula (1) using a well-known technique described in “J. Lin, T. Upadhyaya, and N. Lukenhaus, “Asymptotic Security Analysis of Discrete-Modulated Continuous-Variable Quantum Key Distribution,” Physical Review X 9, 041064 (2019)” or the like, the compression rate γ is calculated to be 0.0127. As the value of the compression rate γ is determined to be lower (a degree of compression is higher), a rate at which the final key is generated is lowered, although security is improved.

In a case where the information received by the reception unit 11 includes at least one of the identification information of the QKD device 20 and the information indicating the designated security level of the quantum key distribution, the control unit 12 may calculate the compression rate γ based on the information. As a result, for example, the compression rate γ can be determined based on the security level designated by the user or the like, for each QKD device 20. In this case, the control unit 12 may calculate a value obtained by multiplying γ in the above formula (1) by a coefficient according to the designated security level, as the corrected compression rate γ. The information regarding the security level for each QKD device 20 and the information regarding the coefficient according to the security level may be set in the information processing apparatus 10 in advance. The control unit 12 may calculate at least one of terms on the right side of the above formula (1) (for example, χ), instead of determining the compression rate γ itself.

Subsequently, the transmission unit 13 transmits information indicating the compression rate γ determined by the control unit 12 to the QKD device 20 (step S103). Here, the transmission unit 13 may transmit the information indicating the compression rate γ to at least one of the QKD device 20-1 and the QKD device 20-2. The information indicating the compression rate γ may be transmitted to the QKD device 20-2 on the reception side and transferred from the QKD device 20-2 to the QKD device 20-1. The information indicating the compression rate γ may be transmitted to the QKD device 20-1 on the transmission side and transferred from the QKD device 20-1 to the QKD device 20-2.

Subsequently, the control unit 12 outputs the information necessary for calculating the compression rate γ and the information indicating the compression rate γ, received by the reception unit 11, in association (step S104). As a result, for example, the user can verify whether the compression rate is properly determined. Here, for example, the control unit 12 may output the information to a log or a display device.

For example, the reception unit 11 may receive information indicating a data size of the final key generated based on the compression rate γ transmitted by the transmission unit 13, from the QKD device 20. Subsequently, the control unit 12 may output the information necessary for calculating the compression rate γ, the information indicating the compression rate γ, and the information indicating the data size of the final key, in association. As a result, for example, the user can verify an operation of the QKD device 20 using the generation rate of the final key by the QKD device 20 and the compression rate in combination.

The control unit 12 may output the information necessary for calculating the compression rate γ, the information indicating the compression rate γ, and the information indicating the security level based on the compression rate γ, in association. As a result, for example, the user can grasp security of communication of the QKD device 20. The security level may be determined according to the identification information of the QKD device 20 or designated by the user or the like, as described above.

The control unit 12 may transmit the information necessary for calculating the compression rate γ and the information indicating the compression rate γ to a destination according to at least one of the transmission side and the reception side of the quantum key distribution. As a result, for example, the user can verify whether the compression rate is properly determined. In this case, the reception unit 11 may receive the identification information of the QKD device 20 on each of the transmission side and the reception side of the quantum key distribution. Then, the control unit 12 may send the information necessary for calculating the compression rate γ and the information indicating the compression rate γ, to a destination such as an email address according to the identification information of each QKD device 20. The destination such as the email address according to the identification information of each QKD device 20 may be set to the information processing apparatus 10 in advance.

The control unit 12 may add a digital signature to the information necessary for calculating the compression rate γ and the information indicating the compression rate γ and transmit the information to the QKD device 20. As a result, for example, the user can verify whether the compression rate is properly determined.

### <Others>

In a case where a method such as the Continuous-Variable QKD (CV-QKD) is used, since the calculation of the compression rate is relatively complicated, calculation cost increases. Therefore, in a case where the QKD device 20 calculates the compression rate, implementation is relatively difficult. Since resources used for the key generation processing are limited in a case where resources required for the calculation of the compression rate increase, a key generation rate is limited. In a case where an approximation table is set to the QKD device 20 in advance and the compression rate is calculated using the table, there is a problem in accuracy and setting of a range of each parameter.

In a case of a configuration in which the QKD device 20 calculates the compression rate, in a case where a compression rate calculating method is changed due to correction or change of the protocol or security certification, there is a possibility that it is necessary to replace (replace) the QKD device 20.

In a case of a configuration in which the QKD device 20 calculates the compression rate, in a case where the user verifies that the value of the compression rate used by the QKD device 20 is correct, the user needs to calculate and confirm the compression rate from the log or the like.

In the present disclosure, the information processing apparatus 10 that calculates the compression rate is a device (an entity) different from the QKD device 20. The information processing apparatus 10 receives protocol information, a parameter measurement value, and the like from the QKD device 20 via the network (the public communication path N2) and calculates and returns the compression rate. As a result, for example, it is not necessary to incorporate a compression rate calculation function having a relatively large processing load into the QKD device 20. Coping with update of the security certification becomes relatively easier. Dynamically coping with various security levels becomes relatively easier.

### Modified Example

The information processing apparatus 10 may be an apparatus included in one housing, but the information processing apparatus 10 of the present disclosure is not limited thereto. Each unit of the information processing apparatus 10 may be achieved by, for example, cloud computing including one or more computers. The information processing apparatus 10 and the QKD device 20 may be housed in the same housing and configured as an integrated information processing apparatus. At least a part of the processing of each functional unit of the information processing apparatus 10 may be executed by the QKD device 20. Such an information processing apparatus 10 is also included in an example of the “information processing apparatus” of the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Some or all of the example embodiments described above may be described as, but are not limited to, the following Supplementary Notes. Some or all of the elements (for example, configurations and functions) described in each Supplementary Note dependent on Supplementary Note 1 can also be dependent on independent Supplementary Notes of other categories by the same dependency relationship. Some or all of the elements described in any Supplementary Note may be applied to various types of hardware, software, recording means for recording software, systems, and methods.

### (Supplementary Note 1)

An information processing apparatus including:
a reception unit configured to receive information necessary for calculating a compression rate in privacy amplification processing in a quantum key distribution from a quantum key distribution device;
a control unit configured to determine the compression rate, based on the information received by the reception unit; and
a transmission unit configured to transmit information indicating the compression rate determined by the control unit to the quantum key distribution device.

### (Supplementary Note 2)

The information processing apparatus according to supplementary note 1, in which the information necessary for calculating the compression rate includes at least one of identification information of the quantum key distribution device and information indicating a designated security level of the quantum key distribution.

### (Supplementary Note 3)

The information processing apparatus according to supplementary note 1 or 2, in which the control unit outputs the information necessary for calculating the compression rate and the information indicating the compression rate, in association.

### (Supplementary Note 4)

The information processing apparatus according to supplementary note 3, in which
the reception unit receives information indicating a data size of a final key generated by the privacy amplification processing, from the quantum key distribution device, and
the control unit outputs the information necessary for calculating the compression rate, the information indicating the compression rate, and the information indicating the data size of the final key, in association.

### (Supplementary Note 5)

The information processing apparatus according to supplementary note 1 or 2, in which the control unit outputs the information necessary for calculating the compression rate, the information indicating the compression rate, and the information indicating the security level based on the compression rate, in association.

### (Supplementary Note 6)

The information processing apparatus according to supplementary note 1 or 2, in which the control unit transmits the information necessary for calculating the compression rate and the information indicating the compression rate, to a destination according to at least one of a transmission side and a reception side of the quantum key distribution.

### (Supplementary Note 7)

The information processing apparatus according to supplementary note 1 or 2, in which the control unit adds a digital signature to the information necessary for calculating the compression rate and the information indicating the compression rate and transmits the information to the quantum key distribution device.

### (Supplementary Note 8)

The information processing apparatus according to supplementary note 1 or 2, in which
the reception unit receives the information necessary for calculating the compression rate in the privacy amplification processing in a plurality of the quantum key distributions, from each quantum key distribution device,
the control unit determines a compression rate of each of the plurality of quantum key distributions, based on each piece of the information received by the reception unit, and
the transmission unit transmits information indicating each compression rate determined by the control unit, to each quantum key distribution device.

### (Supplementary Note 9)

An information processing method including:
receiving information necessary for calculating a compression rate in privacy amplification processing in a quantum key distribution from a quantum key distribution device;
determining the compression rate, based on the received information; and
transmitting information indicating the determined compression rate to the quantum key distribution device.

### (Supplementary Note 10)

A program for causing a computer to execute processing including:
receiving information necessary for calculating a compression rate in privacy amplification processing in a quantum key distribution from a quantum key distribution device;
determining the compression rate, based on the received information; and
transmitting information indicating the determined compression rate to the quantum key distribution device.

1. An information processing apparatus comprising:
at least one memory storing instructions, and
at least one processor configured to execute the instructions to;
receive information necessary for calculating a compression rate in privacy amplification processing in a quantum key distribution from a quantum key distribution device;
determine the compression rate, based on the received information; and
transmit information indicating the determined compression rate to the quantum key distribution device.

2. The information processing apparatus according to claim 1, wherein the information necessary for calculating the compression rate includes at least one of identification information of the quantum key distribution device and information indicating a designated security level of the quantum key distribution.

3. The information processing apparatus according to claim 1, wherein the at least one processor is further configured to execute the instructions to output the information necessary for calculating the compression rate and the information indicating the compression rate, in association.

4. The information processing apparatus according to claim 3, wherein the at least one processor is further configured to execute the instructions to:
receive information indicating a data size of a final key generated by the privacy amplification processing, from the quantum key distribution device, and
output the information necessary for calculating the compression rate, the information indicating the compression rate, and the information indicating the data size of the final key, in association.

5. The information processing apparatus according to claim 1, wherein the at least one processor is further configured to execute the instructions to output the information necessary for calculating the compression rate, the information indicating the compression rate, and information indicating a security level of the quantum key distribution based on the compression rate, in association.

6. The information processing apparatus according to claim 1, wherein the at least one processor is further configured to execute the instructions to transmit the information necessary for calculating the compression rate and the information indicating the compression rate, to a destination according to at least one of a transmission side and a reception side of the quantum key distribution.

7. The information processing apparatus according to claim 1, wherein the at least one processor is further configured to execute the instructions to add a digital signature to the information necessary for calculating the compression rate and the information indicating the compression rate and transmit the information to the quantum key distribution device.

8. The information processing apparatus according to claim 1, wherein the at least one processor is further configured to execute the instructions to:
receive the information necessary for calculating the compression rate in the privacy amplification processing in a plurality of the quantum key distributions, from each quantum key distribution device,
determine a compression rate of each of the plurality of quantum key distributions, based on each piece of the received information, and
transmit information indicating each determined compression rate, to each quantum key distribution device.

9. An information processing method comprising:
receiving information necessary for calculating a compression rate in privacy amplification processing in a quantum key distribution from a quantum key distribution device;
determining the compression rate, based on the received information; and
transmitting information indicating the determined compression rate to the quantum key distribution device.

10. A non-transitory computer-readable medium storing a program for causing a computer to execute processing comprising:
receiving information necessary for calculating a compression rate in privacy amplification processing in a quantum key distribution from a quantum key distribution device;
determining the compression rate, based on the received information; and
transmitting information indicating the determined compression rate to the quantum key distribution device.
